(19) United States
(12) Patent Application Publication
(10) Pub. No.: US 2025/0036555 A1
(43) Pub. Date: Jan. 30, 2025

(54) SYSTEM AND METHOD FOR AUTOMATED TESTING OF USER INTERFACES IN SOFTWARE APPLICATIONS

(71) Applicant: Relicx, Inc, Menlo Park, CA (US)

(72) Inventors: Gurashish Singh Brar, Menlo Park, CA (US); Sushil Kumar, Menlo Park, CA (US); Karan Bavishi, Menlo Park, CA (US)

(21) Appl. No.: 18/786,157

(22) Filed: Jul. 26, 2024

Related U.S. Application Data
(60) Provisional application No. 63/529,130, filed on Jul. 26, 2023.

(51) Int. Cl. G06F 11/36

(52) U.S. Cl. CPC G06F 11/3688

(57) ABSTRACT

One variation of a method includes: accessing a test statement defining a target outcome for a target webpage; capturing a screenshot of the target webpage depicting a set of target content; accessing a set of webpage code defined for the target webpage; transforming the set of webpage code into a sequence of contextual tags, corresponding to the set of target content depicted in the screenshot, to generate a textual representation of the target webpage; generating a prompt including the test statement, the screenshot, and the textual representation; accessing a language model configured to generate responses to test statements based on visual and textual content extracted from corresponding prompts; based on the language model and the prompt, generating a textual response to the test statement representing occurrence of the target outcome at the target webpage; and serving the textual response to a user associated with the organization.

### CROSS-REFERENCE TO RELATED APPLICATIONS

This application claims the benefit of U.S. Provisional Application No. 63/529,130, filed on 26 Jul. 2023, which is incorporated in its entirety by this reference.

### TECHNICAL FIELD

This invention relates generally to the field of user interface testing and more specifically to a new and useful system and method for automated testing of user interfaces in software applications in the field of user interface testing.

### BRIEF DESCRIPTION OF THE FIGURES

FIG. 1 a flowchart representation of a method;

FIGS. 2A, 2B, and 2C are flowchart representations of the method;

FIG. 3 is a flowchart representation of the method; and

FIGS. 4A and 4B are flowchart representations of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

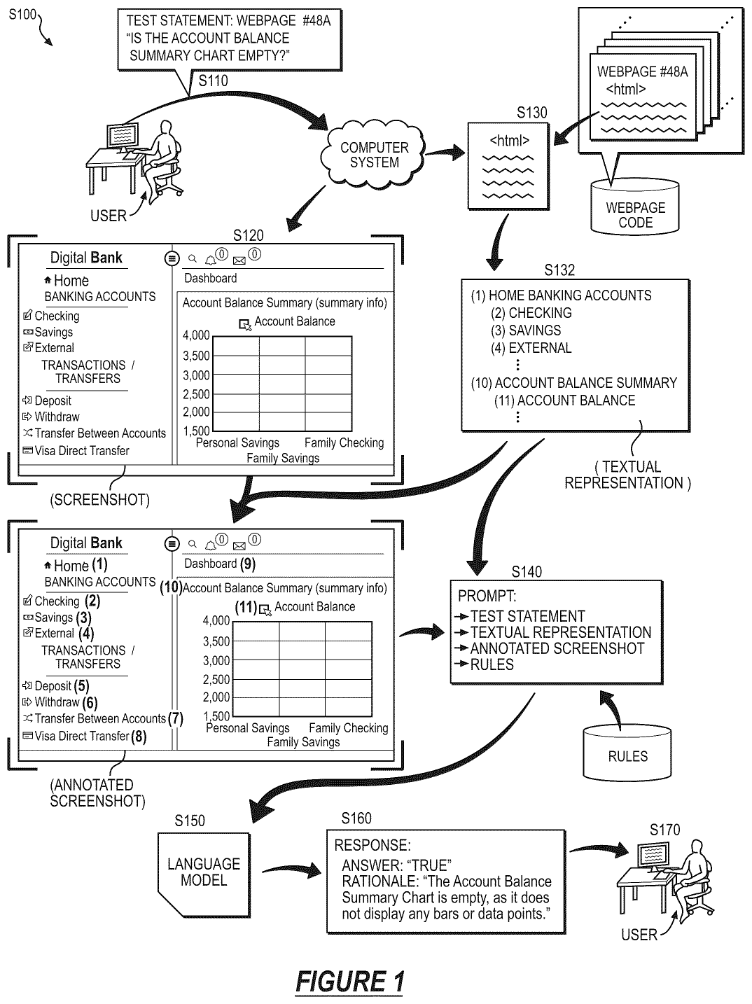

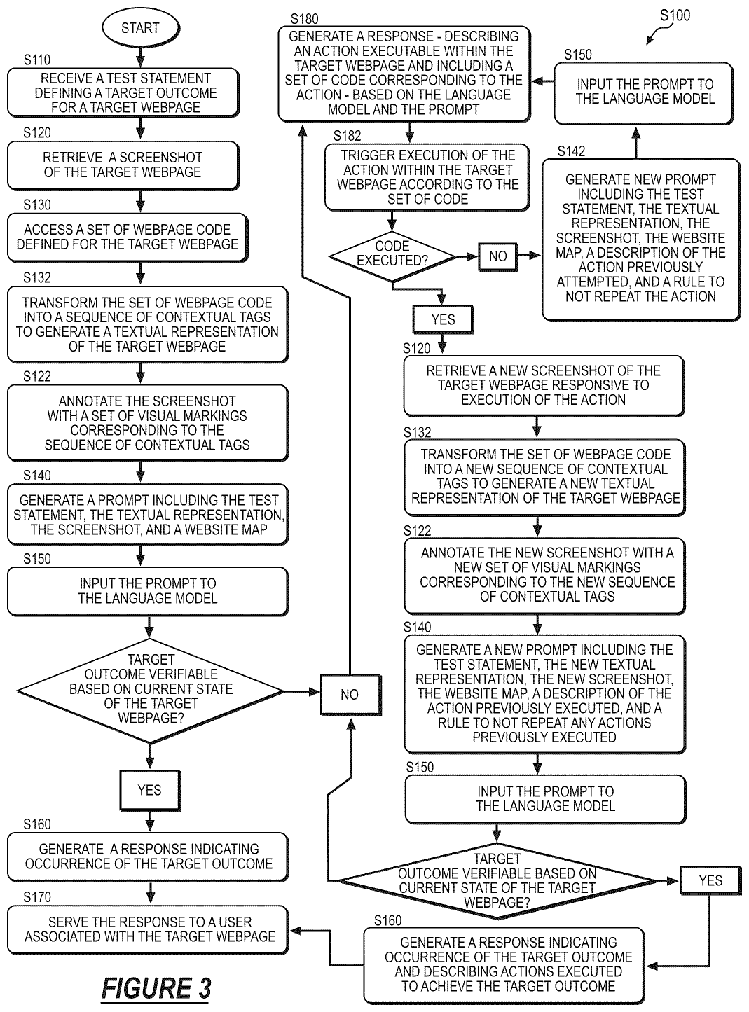

As shown in FIGS. 1, 2A-2C, 3, 4A, and 4B, a method S100 includes: accessing a test statement defining a target outcome associated with contents of a target webpage affiliated with an organization in Block S110; capturing a first screenshot of a first region of the target webpage, in the set of electronic documents, depicting a first set of target content and rendered within a viewport in Block S120; accessing a set of webpage code defined for the target webpage and corresponding to contents of the target webpage in Block S130; transforming the set of webpage code into a first sequence of contextual tags corresponding to the first set of target content depicted in the first screenshot to generate a first textual representation of the first set of target content in Block S132; generating a first prompt including the test statement, an address corresponding to the target webpage, the first screenshot, and the first textual representation of the first set of target content in Block S140; accessing a language model configured to generate responses to test statements based on visual and textual content extracted from corresponding prompts in Block S150; based on the language model and the first prompt, generating a textual response to the test statement representing occurrence of the target outcome at the target webpage in Block S160; and serving the textual response to a user associated with the organization in Block S170.

In one variation, the method S100 further includes: annotating the first screenshot with a first set of visual markings corresponding to the first sequence of contextual tags of the first textual representation, each visual marking, in the first set of visual markings, corresponding to a contextual tag in the first sequence of contextual tags in Block S122. In this variation, Block S140 of the method S100 recites: generating the first prompt including the test statement, the address corresponding to the target webpage, the first screenshot annotated with the first set of visual markings, and the first textual representation of the first set of target content.

### 1.1 Method: Return Sequence of Actions+Code

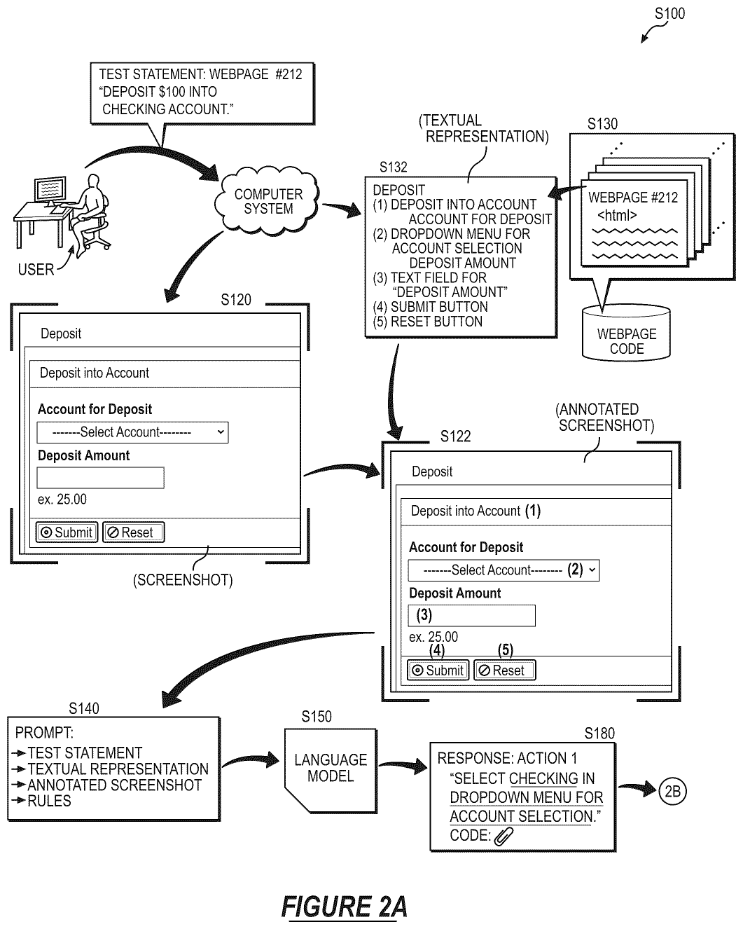

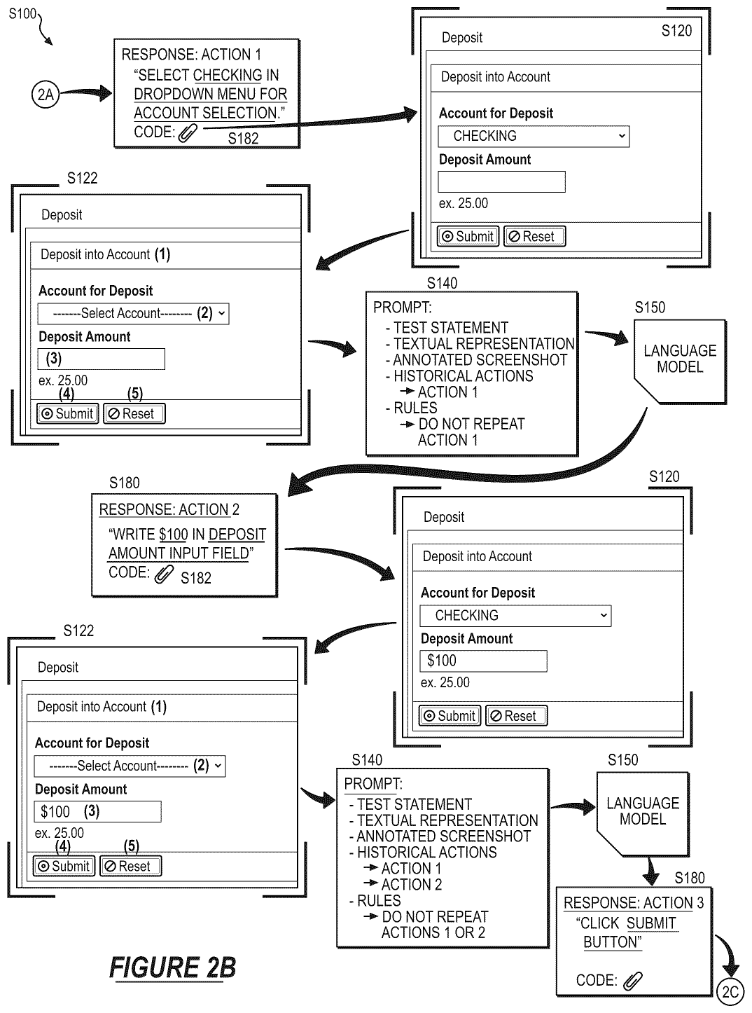

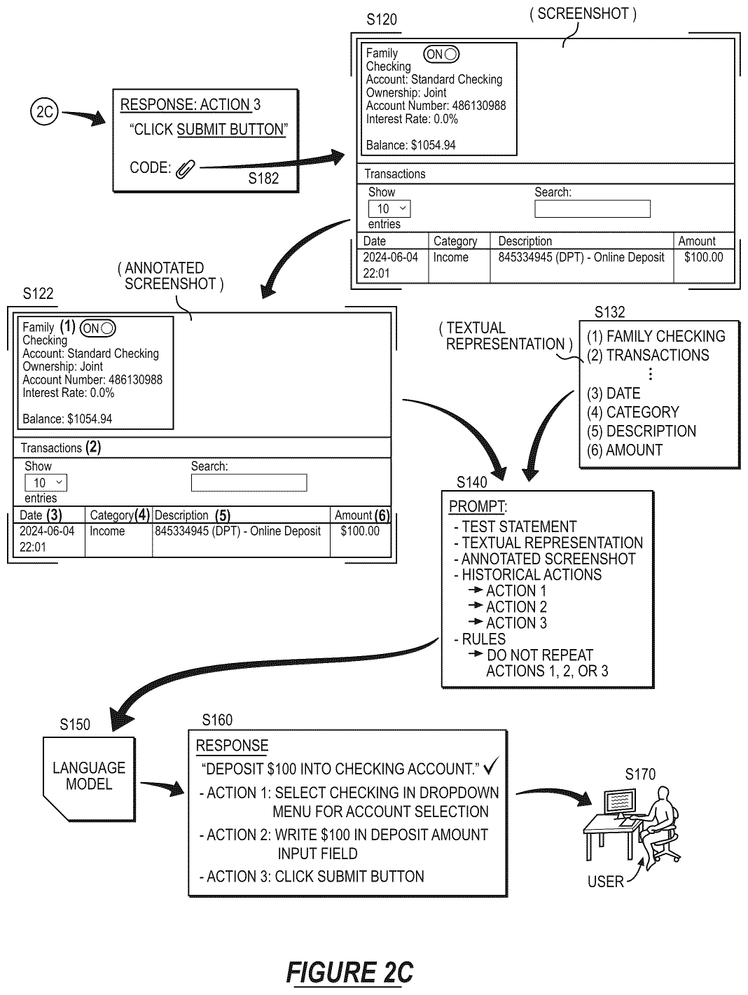

As shown in FIGS. 2A-2C, 3, 4A, and 4B, one variation of the method S100 includes: accessing a test statement defining a target outcome associated with contents of a target webpage affiliated with an organization in Block S110; capturing a first screenshot of a first region of the target webpage depicting a first set of target content and rendered within a viewport in Block S120; accessing a set of webpage code defined for the target webpage and corresponding to contents of the target webpage in Block S130; transforming the set of webpage code into a first sequence of contextual tags corresponding to the first set of target content depicted in the first screenshot to generate a first textual representation of the first set of target content in Block S132; generating a first prompt including the test statement, an address corresponding to the target webpage, the first screenshot, and the first textual representation of the first set of target content in Block S140; accessing a language model configured to generate responses to test statements based on visual and textual content extracted from corresponding prompts in Block S150; based on the language model and the first prompt, generating a first set of code corresponding to a first sequence of actions executable within the target webpage and predicted to yield the target outcome in Block S180; executing the first sequence of actions within the target webpage according to the first set of code output by the language model in Block S182; capturing a second screenshot of a second region of the target webpage depicting a second set of target content and rendered within the viewport in Block S120; transforming the set of webpage code into a second sequence of contextual tags corresponding to the second set of target content depicted in the second screenshot to generate a second textual representation of the second set of target content in Block S132; generating a second prompt including the test statement, the second screenshot, and the second textual representation of the second set of target content in Block S140; based on the language model and the second prompt, generating a textual response to the test statement representing occurrence of the target outcome at the target webpage in Block S160; and serving the textual response to a user associated with the organization in Block S170.

### 1.2 Method: Sequence of Actions+Error

As shown in FIGS. 1, 2A-2C, 3, 4A, and 4B, one variation of the method S100 includes: accessing a test statement defining a target outcome associated with contents of a target webpage in Block S110; capturing a first screenshot of a region of a first target webpage, in a set of webpages, depicting a first set of target content rendered within a viewport in Block S120; accessing a first set of webpage code defined for the first target webpage and corresponding to contents of the first target webpage in Block S130; generating a first textual representation of the first target webpage by transforming the set of webpage code into a first sequence of contextual tags corresponding to the first set of target content depicted in the first screenshot in Block S132; generating a first prompt including the test statement, the first screenshot, and the first textual representation of the first set of target content in Block S140; accessing a language model configured to generate responses to test statements based on visual and textual content extracted from corresponding prompts in Block S150; and, based on the language model and the first prompt, generating a first response describing a first action-executable within the target webpage and predicted to yield the target outcome—and including a first set of code corresponding to the first action in Block S180; triggering execution of the first action within the target webpage according to the first set of code in Block S182; in response to failure to execute the first action, generating a second prompt including the test statement, the first screenshot, the first textual representation, a description of the first action and the first set of code, and a first instruction to not repeat the first action in Block S142; based on the language model and the second prompt, generating a second response describing a second action-executable within the target webpage and predicted to yield the target outcome—and including a second set of code corresponding to the second action in Block S180; and triggering execution of the second action within the target webpage according to the second set of code in Block S182.

In this variation, the method S100 further includes, in response to execution of the second action: capturing a second screenshot of a region of a second instance of the target webpage depicting a second set of target content rendered within the viewport responsive to execution of the first sequence of actions in Block S120; generating a second textual representation of the target webpage by transforming the set of webpage code into a second sequence of contextual tags corresponding to the second set of target content in Block S132; generating a third prompt including the test statement, the second screenshot, the second textual representation, and a description of the second action in Block S140; based on the language model and the third prompt, generating a third response to the test statement representing occurrence of the target outcome and describing the second action in Block S160; and serving the third response to a user associated with the target webpage in Block S170.

### 2. Applications

Generally, Blocks of the method S100 can be executed by a computer system (e.g., a remote computer system, a computer network, a remote server)—in conjunction with an application (e.g., a native or web application)—to: receive a test statement-such as from a computing device accessed by a user (e.g., an engineer, a developer) and executing the application-specifying a target outcome for a target webpage (or other type of electronic document); capture an image (or a “screenshot”) of the target webpage that depicts a set of target content (e.g., textual and/or visual content) contained within a region of the target webpage rendered within the viewport; retrieve a set of webpage code (e.g., HTML code) defined for the target webpage and representing all content contained in the target webpage; leverage the set of webpage code to generate a textual representation (e.g., written in natural language) of the target webpage representing key content-such as including selectable and/or actionable elements-contained within the target webpage and corresponding to the set of target content depicted in the screenshot; retrieve a response-generating model (e.g., a large language model) configured to ingest textual and/or visual signals-such as extracted from test statements and/or corresponding webpage screenshots and textual representations—and automatically return corresponding responses (e.g., in natural language) indicating occurrence of the target outcome; package the test statement, the screenshot, and the textual representation into a prompt for the response-generating model; and feed the prompt to the response-generating model to generate a response (e.g., a natural language response) indicating occurrence of the target outcome-such as whether the target outcome successfully occurred on the target webpage-specified in the test statement. The computer system can then return this response to the user for review (e.g., via the application).

For example, the computer system can receive a test statement requesting verification of a target outcome of: presence of a target element-such as an icon, a text field, an image, a selectable link, etc. on the target webpage; rendering a set of visual data (e.g., graphical data) within a chart or graph responsive to selection of a corresponding element on the target webpage; and/or completion of a target action-such as completion of a deposit into a banking account, updating a chart rendered on the target webpage responsive to selection (e.g., via clicking) of specific data, etc. on the target webpage and/or across several webpages (e.g., of a website) affiliated with an organization. The computer system can then execute Blocks of the method S100 and implement the strategy-generating model to: generate a textual response of “true” in response to confirming presence of the target outcome at the target webpage; and generate a textual response of “false” in response to absence of the target outcome at the target webpage. Additionally, the computer system can implement the language model to generate a textual response that further includes a text string describing a rationale for a “true” or “false” response to the test statement.

Additionally, the computer system can receive a test statement to verify execution of a target outcome (e.g., a target action) corresponding to completion of a target action-such as completion of a deposit into a banking account, logging into an account, submitting a purchase order, etc. on the target webpage and/or across several target webpages (e.g., of a website) affiliated with a website or organization. In this implementation, the computer system can then: implement the response-generating model to generate a response describing one or more actions predicted to yield the target outcome when executed on the target webpage and including a set of code-executable (e.g., by a virtual machine) within the target webpage-corresponding to these actions; and execute the set of code at the target webpage(s) (e.g., via the virtual machine) to trigger execution of these actions, such as to move a cursor to various locations within the target webpage; “click” or select buttons or icons rendered within the target webpage; “type” or add text within text fields rendered within the target webpage; etc. The computer system can then execute Blocks of the method S100 to: generate a new prompt including the (original) test statement, a new screenshot of updated content rendered with the target webpage(s) responsive to execution of the suggested actions, and a new textual representation of the target webpage(s); and feed the prompt to the response-generating model (hereinafter the “language model”) to generate a new response indicating verification of the target outcome-such as in response to the new screenshot and the new textual representation indicating completion of the target outcome—or including one or more additional actions (in combination with a set of corresponding code) predicted to yield the target outcome when executed on the target webpage(s).

Generally, the computer system generates a textual representation of the webpage-representing key content (e.g., actionable and/or selectable content) contained in the target webpage and/or corresponding to content depicted in the screenshot of the target webpage-derived from webpage code (e.g., HTML code) defined for the target webpage. In particular, the computer system can extract elements from the set of webpage code-defining a first data size—to generate a textual representation of the target webpage representing text and selectable and/or interactive features (e.g., icons, buttons, links, text fields) present on the target webpage, and defining a second data size less than the first data size. By thus transforming the set of webpage code into this compressed textual representation of the target webpage-only representative of actionable content contained in the target webpage and omitting non-actionable content (e.g., colors, fonts, background imagery)—the computer system can: reduce an amount of data input to the language model and thus minimize time and compute required to generate a response; and improve accuracy of the language model by feeding targeted data-corresponding to key, actionable content on the target webpage—to the language model.

Furthermore, by combining the textual representation of the target webpage with the screenshot of the target webpage in the prompt fed to the language model, the computer system can enable the user (e.g., a developer, an engineer) to write test statements in natural language rather than write code-based test statements, thereby reducing resources dedicated to drafting test statements-such as including queries (or “assertions”) and/or commands for target webpage(s)—and maximizing resilience of these test statements to changes in structure and/or function of corresponding webpages over time. In particular, for each instance of executing the test statement, the computer system can: retrieve a new screenshot of a target webpage; generate a new textual representation of the target webpage based on a current set of webpage code defined for the target webpage; and feed a prompt-including the test statement, the new screenshot, and the textual representation of the target webpage—to the language model to generate a response to the test statement accordingly, such as without requiring updates and/or modifications to the test statement (e.g., entered manually by the user) over time, regardless of changes to the target webpage. Furthermore, by storing the test statement in natural language-rather than storing a code-based test statement—the computer system can minimize data storage allocated to test statements generated for a target webpage over time. For example, the computer system can store a test statement-generated for a target webpage—of “Is there a log-in button displayed on the webpage?” without requiring generation and/or storage of complex code for evaluating the test statement.

Blocks of the method S100 are generally described below as executed by the computer system (e.g., in conjunction with an application and/or virtual machine) to verify and/or execute test statements-such as including queries (or “assertions”) or commands-defined for a target webpage(s). However, Blocks of the method S100 can be executed by the computer system (e.g., in conjunction with an application and/or virtual machine) to verify and/or execute test statements defined for any type of electronic document(s), such as including a target webpage(s), a target landing page(s) within a web application, a target landing page(s) within a native application, etc.

### 2.1 Example: Boolean Response

In one example, a user (e.g., an engineer, a web developer) may initiate a test for verifying whether a log-in button is displayed within a target webpage (e.g., a log-in page) upon navigation to the target webpage. In this example, the computer system can receive a test statement-such as including a query-entered by the user that recites: “Is the log-in button displayed within the target webpage?”

In this example, in response to receiving the test statement, the computer system can: capture a screenshot of a region of the target webpage rendered within a viewport and depicting a set of target content associated with the test statement; access a set of HTML code generated for the target webpage and representing contents-such as including selectable elements, text, iconography, images, colors (e.g., background colors, text colors), text fonts, etc.—of the target webpage; and leverage the set of HTML code to derive a textual representation (or “wireframe”) of the target webpage representing key content of the target webpage relevant to the test statement, such as outlining a set of text, icons, images, and/or selectable elements (e.g., including the log-in button) encoded for on the target webpage.

The computer system can then generate a prompt—for processing by the language model—that includes: the test statement entered by the user; the screenshot depicting the set of target content rendered within the target webpage; and the textual representation of the target webpage. The computer system can then: input the prompt to the language model to generate a response-such as a textual response of “true” if the log-in button is rendered within the target webpage or “false” if the log-in button is not rendered within the target webpage—to the test statement; and return this response to the user.

In particular, the language model can be configured to: ingest the prompt including the test statement, the screenshot depicting the set of target content (e.g., in a current state during execution of the test), and the textual representation of key content contained in the webpage (e.g., text, headings, selectable features, visual and/or numerical data); and output a response to the prompt indicating whether the log-in button is displayed within the target webpage, such as based on visual and language signals extracted from the screenshot, the textual representation, and the test statement.

The computer system can thus repeat this process to verify whether the log-in button is displayed on the target webpage-regardless of changes to the target webpage, the set of HTML code over time, and/or device characteristics (e.g., mobile, desktop, operating system, location, language) of devices accessing the target webpage—by: accessing the test statement; capturing a new screenshot of the target webpage, generating a new textual representation of key content contained in the target webpage;—generating a new prompt-including the test statement, the new screenshot, and the new textual representation—for serving to the language model; and returning a response-indicating whether the “log-in” button is displayed on the target webpage-output by the language model to the user for verification of rendering of the “log-in” button across all instances of the target webpage over time.

In this example, the computer system therefore enables the user to write this test statement-reciting “Is the log-in button displayed within the target webpage?”—in natural language terms that can be ingested by the language model and is resilient to changes in the structure and/or function of the target webpage over time, rather than requiring the user to write a code-based test statement that may require edits over time as the structure and/or function of the target webpage is updated.

### 2.2 Example: Actions+Code

In another example, a user may initiate a test for verifying successful completion of a deposit into a checking account accessed within a website affiliated with a banking organization. In this example, the computer system can receive a test statement—such as including a command—that recites: “Deposit S100 into the personal checking account.”

In response to receiving the test statement, the computer system can: capture a first screenshot of a region of a first target webpage-such as corresponding to an “account home” page-rendered within a viewport and depicting a first set of target content associated with the test statement; access a first set of HTML code generated for the first target webpage and representing contents-such as including selectable elements, text, iconography, images, colors (e.g., background colors, text colors), text fonts, etc.—of the first target webpage; and leverage the first set of HTML code to derive a first textual representation (or “wireframe”) of the first target webpage representing key content of the first target webpage relevant to the test statement, such as outlining a set of text, icons, images, and/or selectable elements encoded for on the first target webpage.

Then, the computer system can generate a first prompt—for processing by the language model—that includes: the test statement entered by the user; the first screenshot depicting the first set of target content rendered within the first target webpage; and the first textual representation of the first target webpage. The computer system can then input the first prompt to the language model to generate a first response. In particular, in this example, the language model can: ingest the first prompt; and—in response to inability to verify completion of the command (e.g., corresponding to “deposit S100 into the personal checking account”) based on a current state of the first target webpage (e.g., the “account home page”)—output a first response to the first prompt describing a first action-predicted to enable completion of the command and/or drive toward completion of the command—for execution within the first target webpage. Furthermore, the language model can output a first set of code corresponding to the first action.

For example, the computer system can: input the first prompt to the language model; and receive a first response describing a first action of “click the ‘deposit’ button on the ‘account home page’ to navigate to the ‘deposit page’” and including a first set of code corresponding to the first action. The computer system-such as in combination with a virtual machine—can then automatically execute the first action via execution of the first set of code to navigate to the ‘deposit page’ within the website.

Then, the computer system can: capture a second screenshot of a region of the second target webpage-corresponding to a “deposit” page-rendered within a viewport and depicting a second set of target content associated with the test statement; access a second set of HTML code generated for the second target webpage and representing contents of the second target webpage; and leverage the second set of HTML code to derive a second textual representation of the second target webpage representing key content of the second target webpage relevant to the test statement.

The computer system can then generate a second prompt—for processing by the language model—that includes: the test statement entered by the user; the second screenshot depicting the second set of target content rendered within the first target webpage; the second textual representation of the second target webpage (e.g., the “deposit” page); and/or a description of the first action-already completed—and a first rule to not repeat the first action. The computer system can then input the second prompt to the language model to generate a second response: describing a second action-predicted to enable completion of the command and/or drive toward completion of the command—for execution within the second target webpage; and including a second set of code corresponding to the second action. For example, the computer system-such as in combination with a virtual machine—can: receive a second response describing a second action of “write S100 into the ‘deposit amount’ input field” and including a second set of code corresponding to the second action; and automatically execute the second action via execution of the second set of code to write ‘S100’ into the ‘deposit amount’ input field rendered on the second target webpage (e.g., the “deposit page”) within the website.

Then, the computer system can: capture a third screenshot of a region of the second target webpage (e.g., corresponding to the “deposit” page) rendered within the viewport and depicting a third set of target content-including the ‘deposit amount’ input field displaying “S100”-associated with the test statement; and access the second visual representation generated for the second target webpage. The computer system can then generate a third prompt—for processing by the language model—that includes: the test statement entered by the user; the third screenshot depicting the third set of target content rendered within the second target webpage; the second textual representation of the first target webpage; and/or a description of the first and second actions-already completed—and a rule to not repeat the first or second action.

The computer system-such as in combination with a virtual machine—can then: input the third prompt to the language model to generate a third response describing a third action-predicted to enable completion of the command—for execution within the second target webpage and including a third set of code corresponding to the third action; receive a third response describing a third action of “click the ‘submit’ button” and including a third set of code corresponding to the third action; and automatically execute the third action via execution of the third set of code to click the ‘submit’ button rendered on the second target webpage (e.g., the “deposit page”) and thus verify completion of the command and successful deposit of S100 into the personal checking account, thereby verifying functionality of this command within the website.

### 3. Test Statement

Block S110 of the method S100 recites accessing a test statement defining a target outcome associated with contents of a target webpage.

Generally, the computer system can access a test statement requesting confirmation and/or completion of a target outcome across one or more webpages—or any other type of electronic document (e.g., a webpage, a landing page within a native application)—affiliated with a particular organization.

For example, the computer system can receive a test statement-such as including a query (or an “assertion”) and/or a command-requesting verification of a target outcome of: presence of a target feature-such as an icon, a text field, an image, a selectable link, etc. on the target webpage; and/or completion of a target action-such as completion of a deposit into a banking account, updating a chart rendered on the target webpage responsive to selection (e.g., via clicking) of specific data, etc.—on the target webpage and/or across several webpages (e.g., of a website) affiliated with an organization.

Generally, the computer system can receive a test statement from a user (e.g., written by the user)—via a computing device (e.g., a tablet, a desktop computer, a smartphone) accessed by the user-requesting verification of a target outcome.

In one implementation, the computer system can interface with a test portal accessed by the user to receive test statements generated by the user. For example, within the test portal, the user may: specify a target webpage for generation of a new test associated with the target webpage; and enter or write a test statement-requesting verification of a target outcome (e.g., presence of a particular feature on the target webpage, completion of a transaction within the target webpage)—in natural language for the target webpage. The computer system can then receive this test statement via the test portal and execute Blocks of the method S100 accordingly to: return a response to the test statement-indicating occurrence of the target outcome within the target webpage—to the user via the test portal; and/or store the test statement-associated with the target webpage—for future implementation at instances of the target webpage, such as in response to the user confirming integration of the new test for the target webpage.

### 3.1 Textual Representation of Webpage

Blocks S130 and S132 of the method S100 recites: accessing a set of webpage code defined for the target webpage and corresponding to contents of the target webpage; and transforming the set of webpage code into a sequence of contextual tags corresponding to the set of target content depicted in the screenshot to generate a textual representation of the target webpage.

Generally, the computer system can access a document specifying a set of webpage code (e.g., HTML code) corresponding to the target webpage and representing all content-such as including textual content (e.g., titles, headings, bodies of text), visual content (e.g., icons, images, colors, fonts, themes), selectable and/or interactive content (e.g., buttons, links, text fields), etc.—contained in the target webpage. The computer system can then leverage the set of webpage code to generate a textual representation (or “wireframe”) of the target webpage that represents key content on the target webpage that may be relevant to the test statement.

In particular, the computer system can extract elements from the set of webpage code (e.g., HTML code)—defining a first data size—to generate a textual representation of the target webpage representing text and selectable and/or interactive features (e.g., icons, buttons, links, text fields) present on the target webpage, the textual representation defining a second data size less than the first data size. For example, the computer system can: access a document defining a set of HTML code—of a first data size exceeding 100 kilobytes—for a target webpage; and, based on the set of HTML code, derive a textual representation of the target webpage-representative of key content (e.g., actionable content) present on the target webpage—of a second data size less than one kilobyte.

The computer system can therefore generate a compressed, textual representation of the target webpage based on the webpage code provided for the target webpage, thereby: reducing an amount of data input to the language model and thus reducing an amount of time and compute required by the language model to generate a response; and prioritizing input of high-value data corresponding to key content associated with the test statement and withholding input of lower-value data-such as corresponding to extraneous content (e.g., colors, fonts, background imagery, non-actionable items) represented in the set of webpage code for the target webpage-thereby improving accuracy of the language model and further reducing time required to generate a response.

In one implementation, the computer system can transform the set of webpage code defined for the target webpage into a sequence of contextual tags corresponding to target content depicted in the screenshot—of a region of the target webpage rendered with a viewport—to generate the textual representation of the target webpage.

In particular, in this implementation, the computer system can: access the set of webpage code (e.g., HTML code) defined for the target webpage; identify a set of actionable webpage elements-including key text (e.g., labels, headers), dynamic visual elements (e.g., charts, tables), buttons, hyperlinks, text fields, etc.—represented in the set of webpage code; and, for each webpage element, in the set of webpage elements, generate a contextual tag describing and/or representing the webpage element.

In particular, in one example, the computer system can leverage the set of webpage code-encoding for a set of webpage content included in the target webpage—to generate a textual representation of the target webpage that includes a sequence of contextual tags encoding for a set of actionable webpage elements, in the set of webpage content, the sequence of contextual tags including: a first contextual tag-corresponding to a first actionable webpage element present on the target webpage-indicating a first element type of “text field” and including a text string of “withdrawal amount”; and a second contextual tag-corresponding to a second actionable webpage element present on the target webpage-indicating a second element type of “icon” and including a text string of “submit”.

### 3.2 Screenshot of Target Content+Annotations

Block S120 of the method S100 recites: capturing a first screenshot of a first region of the target webpage, in the set of electronic documents, depicting a first set of target content and rendered within a viewport.

Generally, in response to receiving or accessing a test statement specifying a target webpage (or a target landing page within a native or web application), the computer system can capture a screenshot (i.e., a digital image) of a particular region-depicting a set of target content associated with the test statement—of the target webpage.

Furthermore, Block S122 of the method S100 recites: annotating the screenshot with a set of visual markings corresponding to the sequence of contextual tags in the textual representation of the target webpage, each visual marking, in the set of visual markings, corresponding to a contextual tag in the sequence of contextual tags.

Generally, in one implementation, the computer system can: capture a screenshot of the target webpage depicting a set of target content; access the set of webpage code (e.g., HTML code) defined for the target webpage; transform the set of webpage code into a sequence of contextual tags corresponding to key content on the target webpage-including the set of target content depicted in the screenshot—to generate the first textual representation; and annotate the screenshot with a set of visual markings (e.g., alphanumerical identifiers or labels) corresponding to the sequence of contextual tags, such that each visual marking, in the set of visual markings, corresponds to a contextual tag in the sequence of contextual tags.

For example, the computer system can transform the set of webpage code into the sequence of contextual tags—to generate the textual representation of the target webpage-including: a first contextual tag including a first text string-describing a first interactive feature present on the target webpage—and a first identifier linked to the first text string; and a second contextual tag including a second text string-describing a second interactive feature present on the target webpage—and a second identifier linked to the second text string. The computer system computer system can then: annotate the first interactive feature, depicted in the screenshot, with a first visual marking corresponding to (e.g., equivalent) the first identifier; and annotate the second interactive feature, depicted in the screenshot, with a second visual marking corresponding to the second identifier.

In one example, the computer system can derive a textual representation of the target webpage that includes a sequence of contextual tags including: a first contextual tag including a first text string-indicating a first feature type of a text field present on the target webpage and corresponding text of “username” rendered adjacent the text field—and a first numerical identifier of “1” linked to the first text string; and a second contextual tag including a second text string-indicating a second feature type of a clickable icon present on the target webpage and corresponding text of “submit” rendered on the clickable icon—and a second numerical identifier of “2” linked to the second text string. The computer system can then: annotate the screenshot with the first identifier of “1” at and/or over the “username” text field, thereby linking the “username” text field depicted in the screenshot to the first contextual tag included in the textual representation of the target webpage; and annotate the screenshot with the second identifier of “2” at and/or over the clickable “submit” icon, thereby linking the clickable “submit” icon depicted in the screenshot to the second contextual tag included in the textual representation of the target webpage.

In this example, the computer system can therefore: transform the set of webpage code into enumerated tags representing each actionable feature (e.g., clickable and/or selectable icons, text, links) on the target webpage; annotate the screenshot with these enumerated tags; and thus provide additional context to the language model regarding possible actions that can be executed within the target webpage and selectable features corresponding to these possible actions.

### 4. Prompt Generation

Block S140 of the method S100 recites: generating a prompt including the test statement, an address corresponding to the target webpage, the screenshot, and the textual representation of the target webpage.

Generally, the computer system can access and/or generate a set of prompt content including: a screenshot depicting a set of target content on the target webpage; a textual representation of the target webpage-representing key content contained in the target webpage-derived from a set of webpage code (e.g., HTML code) defined for the target webpage; an address (e.g., a URL) associated with the target webpage, and the test statement defining the target outcome for the target webpage. The computer system can then compile this set of prompt content into a prompt that can be input to the language model.

The computer system can further append the set of prompt content with: a set of rules defined for the language model for responding to the prompt and/or test statement; a set of historical data representing historical responses output by the language model and/or historical actions executed by the computer system responsive to the test statement; and/or a website map (e.g., as described below)—derived for a website including the target webpage-representing historical actions and/or sequences of actions executed within the target webpage and/or website.

For example, the computer system can further append the prompt-input to the language model—with a set of rules (or “instructions”) defined for the test statement, the target webpage, and/or the organization associated with the target webpage. Additionally or alternatively, the computer system can append the prompt with a set of generic rules agnostic to the test statement. For example, the computer system can append the prompt with a set of rules including: a first rule (or “instruction”) to “not ignore error messages”; a second rule to dismiss “pop-up” windows; and a third rule to implement “mock” identifiers when required, such as including a mock zip code, a mock location, a set of mock log-in information; etc.

### 5. Response Generation: Prompt+Language Model

Blocks S150 and S160 of the method S100 recite: accessing a language model configured to generate textual responses (e.g., a natural language response, a set of executable code) to test statements based on visual and textual content extracted from corresponding prompts; and, based on the language model and the prompt, generating a response to the test statement representing occurrence of the target outcome at the target webpage.

Generally, the computer system can input the prompt-including the test statement, a screenshot of the target webpage, and a textual representation of the target webpage and/or of the screenshot-into the language model to generate a response to the test statement, such as including: a text string of “true”-indicating confirmation and/or completion of a target outcome specified in the test statement—or “false” indicating absence of and/or failure to complete the target outcome within the target webpage.

### 5.1 Response Generation: “True” or “False”

In one implementation, the computer system can implement the language model to generate a response to the test statement indicating whether a target outcome-specified in the test statement-occurred within the target webpage.

Generally, in this implementation, the computer system can: access a test statement defining a target outcome associated with contents of a target webpage affiliated with an organization; capture a screenshot of a region of the target webpage depicting a set of target content rendered within a viewport; access a set of webpage code defined for the target webpage and corresponding to contents of the target webpage; transform the set of webpage code into a sequence of contextual tags corresponding to the set of target content depicted in the screenshot to generate a textual representation of the set of target content; generate a prompt including the test statement, an address corresponding to the target webpage, the screenshot, and first textual representation of the set of target content; and feed the prompt to the language model to generate a textual response to the test statement representing occurrence of the target outcome at the target webpage. The computer system can then serve the textual response to a user associated with the target webpage (e.g., via the application).

For example, the computer system can: receive a test statement requesting verification of presence of a target element (e.g., a visual element, a textual element, an interactive element) within a target webpage; and implement the language model to generate a textual response of “true” if the target element is present (or “rendered”) on the target webpage or “false” if the target element is absent from (or “not rendered on”) the target webpage.

### 5.2 Response: Sequence of Actions+Executable Code

Block S180 and S182 of the method S100 recite: based on the language model and the prompt input to the language model, generating a set of code corresponding to a sequence of actions executable within the target webpage and predicted to yield the target outcome; and executing the sequence of actions within the target webpage according to the set of code output by the language model.

In this implementation, the computer system can implement the language model—by feeding the prompt to the language model—to: generate a text string describing a sequence of actions (e.g., one or more actions) executable within the target webpage and predicted to achieve and/or yield the target outcome when executed within the target webpage; and a set of code-executable by the computer system and/or a virtual machine interfacing with the computer system-corresponding to the sequence of actions. For example, the computer system and/or virtual machine can execute the set of code—at the target webpage—to: move a cursor to various locations within the target webpage; “click” or select buttons or icons rendered within the target webpage; “type” or add text within text fields rendered within the target webpage; etc.

For example, the language model can return a response including a text string describing a sequence of actions (e.g., one or more actions) executable within the target webpage-such as including a first action corresponding to “clicking” on (or “selecting”) a heading (e.g., corresponding to a hyperlink) to navigate to a subsequent webpage, a second action corresponding to writing text within a text field, and a third action corresponding to “clicking” a submit button to submit text entered within the text field and display data within a chart—and predicted to yield the target outcome. In this example, the language model can also return a set of code-included in the response in combination with the text string describing the sequence of actions-such as including: a first subset of code corresponding to the first action of “clicking” on the heading; a second subset of code corresponding to the second action of writing text within the text field; and a third subset of code corresponding to “clicking” the submit button. The computer system can thus: receive this response-including the text string and the set of code-output by the language model; execute the set of code (e.g., via a virtual machine) to complete the sequence of actions within the target webpage(s); and verify occurrence and/or completion of a target outcome specified in the original test statement responsive to (successful) execution of the sequence of actions.

### 5.2.1 Action Execution+New Prompt Generation

Generally, as described above, the computer system can implement the language model to generate a response (e.g., to the prompt) describing a sequence of actions-predicted to yield the target outcome specified in the test statement-executable within the target webpage(s) and a corresponding set of code corresponding to the sequence of actions.

In one implementation, the computer system can: input a prompt-including a test statement, a screenshot of a first target webpage, and a textual representation of the first target webpage—to the language model; receive a first response from the language model describing a first action executable within the first target webpage and including a first set of code corresponding to the first action, such as in response to inability to verify and/or complete the target outcome at the first target webpage; execute (or trigger execution of) the first action within the first target webpage (e.g., via a virtual machine) to navigate to a second target webpage (e.g., a second instance of the first target webpage or a new target webpage); and input a new prompt-including the test statement, a new screenshot of the second target webpage, and a new textual representation of the second target webpage—to the language model. The computer system can then receive a second response from the language model: indicating completion of the target outcome in response to verifying occurrence of the target outcome; or—in response to inability to verify and/or complete the target outcome at the second target webpage-describing a second action executable within the second target webpage and including a second set of code corresponding to the second action. The computer system can then repeat this process until receipt of a response indicating verification of occurrence of the target outcome specified in the test statement.

For example, in response to receiving a test statement specifying a target outcome for a set of target webpages, the computer system can: capture a first screenshot of a region of a first target webpage, in the set of webpages, rendered within a viewport and depicting a first set of target content; access a first set of webpage code generated for the first target webpage and representing contents of the first target webpage; transform the first set of webpage code into a first sequence of contextual tags-corresponding to the first set of target content depicted in the first screenshot—to generate a first textual representation of the first set of target content; leverage the first set of HTML code to derive a first textual representation of the first target webpage (e.g., as described above); generate a first prompt including the test statement, the first screenshot, and the first textual representation; input the first prompt to the language model; and, based on the language model and the first prompt, in response to inability to verify and/or complete the target outcome at the first target webpage, generate a first response describing a first action-predicted to enable completion of the target outcome and/or drive toward completion of the target outcome—for execution within the first target webpage and including a first set of code corresponding to execution of the first action.

The computer system can then: execute the first action within the first target webpage according to the first set of code (e.g., via a virtual machine) to load a second target webpage, such as corresponding to a second instance of the first target webpage and/or a different target webpage (e.g., within a website including the first target webpage); capture a second screenshot of a second region of the second target webpage depicting a second set of target content and rendered within the viewport; access a second set of webpage code generated for the second target webpage and representing contents of the second target webpage; transform the second set of webpage code into a second sequence of contextual tags-corresponding to the second set of target content depicted in the second screenshot—to generate a second textual representation of the second set of target content; generate a second prompt including the test statement, the second screenshot, and the second textual representation; input the second prompt to the language model; and, based on the language model and the first prompt, in response to inability to verify and/or complete the target outcome at the second target webpage, generate a second response describing a second action-predicted to enable completion of the target outcome and/or drive toward completion of the target outcome—for execution within the second target webpage and including a second set of code corresponding to execution of the second action. The computer system can then repeat this process to execute the second action, a third action, a fourth action, etc., until receiving a response indicating verification of occurrence of the target outcome specified in the test statement.

### 5.2.2 Error: Non-Executable Action

In one implementation, the computer system can generate a new prompt-indicating failure to execute the sequence of actions and/or set of code output by the language model-requesting a replacement sequence of actions and/or a replacement set of code different from the (original) sequence of actions and/or set of code previously attempted.

In particular, in this implementation, Blocks of the method S100 can include: in response to failure to execute a first sequence of actions according to a first set of code output by the language model, generating a new prompt—for inputting to the language model-including the (original) test statement, the screenshot, the textual representation, a description of the first sequence of actions and/or the first set of code, and an instruction to not repeat the first sequence of actions; based on the language model and the new prompt, generating a second textual response including a second set of code corresponding to a second sequence of actions executable within the target webpage and predicted to yield the target outcome; and executing the second sequence of actions within the target webpage according to the second set of code (e.g., via the virtual machine).

Therefore, in this implementation, in response to receipt of an error (e.g., from the virtual machine) responsive to execution of the set of code output by the language model, the computer system can automatically generate a new prompt-including a list of historical actions previously completed and/or attempted (e.g., by the virtual machine) and an instruction (or “rule”) to not suggest actions included in the list of historical actions-requesting a new sequence of actions and corresponding code for execution within the target webpage.

For example, the computer system can: receive a test statement defining a target outcome corresponding to execution of a particular task (e.g., logging in to a user account, completing a deposit within a checking account, submitting a purchase) within a target webpage; capture a first screenshot of a region of the target webpage rendered within a viewport and depicting a first set of target content; access a first set of HTML code generated for the target webpage and representing contents-such as including selectable elements, text, iconography, images, colors (e.g., background colors, text colors), text fonts, etc.—of the target webpage; generate a first textual representation of the target webpage-representing key content on the target webpage relevant to the test statement, such as outlining a set of text, icons, images, and/or selectable elements encoded for on the target webpage-based on the set of HTML code; generate a first prompt including the test statement, the first screenshot, and the first textual representation; and input the first prompt into the language model to generate a first response including a (textual) description of a first action (e.g., clicking on a selectable element, writing text within a text field) and a first set of code-corresponding to the first action-predicted to yield the target outcome and/or drive toward completion of the target outcome when executed within the target webpage.

Then, the computer system can: execute the first set of code (e.g., via the virtual machine) to trigger the first action within the target webpage; and, in response to an error in the first set of code—and/or inability to complete the first action-receive an “error” response indicating failure to complete the first action with the target webpage.

The computer system can then generate a second prompt including: the test statement; the first screenshot; the first textual representation; the first set of code and a description of the first action; a description of the “error” response associated with execution of the first set of code within the target webpage; a first instruction (or “rule”) to suggest a next action-predicted to yield the target outcome and/or drive toward completion of the target outcome—in replacement of the first action and provide a corresponding set of code; and a second instruction (or “rule”) to not repeat suggestion of the first action, such that the next action recommended is different from the first (failed) action.

The computer system can then: input this second prompt into the language model to generate a second response including a (textual) description of a second action and a second set of code-corresponding to the second action-predicted to yield the target outcome and/or drive toward completion of the target outcome when executed within the target webpage; and execute the second set of code (e.g., via the virtual machine) to trigger the second action within the target webpage.

Then, in response to successful execution of the second set of code-corresponding to completion of the second action within the target webpage—the computer system can: capture a second screenshot of a region of the target webpage rendered within the viewport and depicting a second set of target content rendered within the target webpage responsive to execution of the second action; access the first textual representation of the target webpage; generate a third prompt including the test statement, the second screenshot, and the first textual representation; and input the third prompt into the language model to generate a third response including a (textual) description of a third action and a third set of code-corresponding to the third action—predicted to yield the target outcome and/or drive toward completion of the target outcome when executed within the target webpage, such as in response to incompletion of the target outcome within the target webpage. Alternatively, in response to execution of the second action yielding completion of the target outcome, the computer system can: input the third prompt into the language model to generate a third response including a (textual) description of the second action and indicating occurrence of the target outcome (e.g., logging in to a user account, completing a deposit within a checking account, submitting a purchase) within the target webpage; and return the third response to the user (e.g., via the user portal).

### 5.2.3 New Prompt+Historical Actions

In one implementation, the computer system can append the prompt with a description of a sequence of actions previously executed during evaluation of a particular test statement.

In particular, in this implementation, the computer system can: receive a test statement defining a target outcome associated with contents of a target webpage; implement the methods and techniques described above to generate a first prompt including the test statement, a first screenshot of the target webpage, and a first textual representation of the target webpage; input the first prompt to the language model to generate a first response describing a first action (e.g., clicking a button, writing text in a text field, navigating to a second target webpage)—and corresponding executable code—predicted to yield and/or drive toward completion of the target outcome; execute the first action (e.g., via a virtual machine) at the target webpage; implement the methods and techniques described above to generate a second prompt including the test statement, a second screenshot of the target webpage (e.g., captured after execution of the first action), and a second textual representation of the target webpage; and append the second prompt with a description of the first action previously executed within the target webpage. Furthermore, the computer system can append the second prompt with a rule instructing the language model to not repeat any actions-including the first action—previously executed during evaluation of the test statement.

The computer system can then input the second prompt to the language model to generate a second response-such as describing a second action and corresponding code and/or confirming completion of the target outcome-based on the rule and information provided in the second prompt.

### 6. Website Map: Flow Pathways

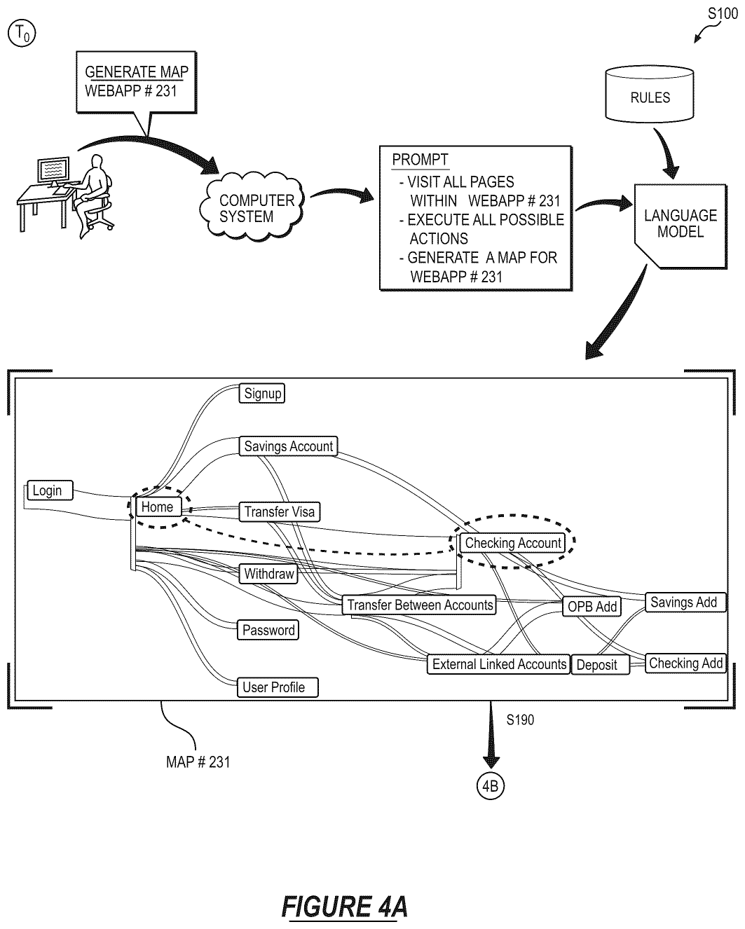

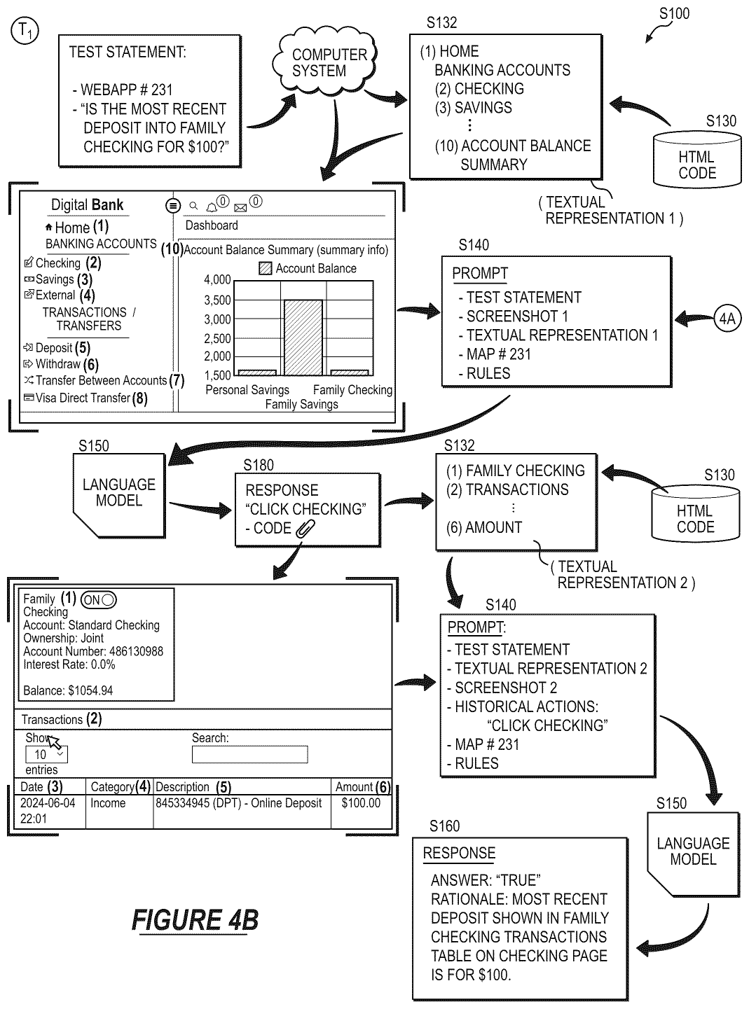

In one variation, as shown in FIGS. 4A and 4B, Block S190 of the method recites accessing a website map defining a set of webpages (e.g., forming a website)—including the target webpage—and a corpus of pathways between webpages in the set of webpages.

For example, the computer system can access a website map-derived for a particular website-defining: a set of webpages including a “log-in” webpage, a “home” webpage, a “checking account” webpage, and a “savings account” webpage, and a “deposit” webpage; a first pathway from the “log-in” webpage to the “home” webpage; a second pathway from the “home” webpage to the “checking account” webpage; a third pathway from the “home” webpage to the “savings” account webpage; a fourth pathway from the “home” webpage to the “deposit” webpage; a fifth pathway from the “checking account” webpage to the “deposit” webpage; a sixth pathway from the “savings account” webpage to the “deposit” webpage; etc.

Additionally, for each webpage, in the set of webpages, the computer system can link a set of components present on the webpage to the webpage within the website map. For example, in the preceding example, the computer system can associate a set of components-such as including a “navigation sidebar” and a “deposit form”—with the “deposit” webpage. Furthermore, for each webpage, in the set of webpages, the computer system can link a description of the webpage to the webpage within the website map. For example, in the preceding example, the computer system can associate a textual description-such as reciting “the purpose of this webpage appears to be a banking application interface allowing a user to perform banking transactions such as deposits”—with the “deposit” webpage.

Additionally or alternatively, the computer system can access a website map defining possible and/or historical sequences of actions executed within (or across) one or more target webpages. For example, the website map can define a first sequence of actions corresponding to: navigating to an “account log-in” page; writing a set of log-in credentials within a corresponding text field rendered in the “account log-in” page; clicking a “submit” button rendered adjacent the corresponding text field in the “account log-in” page; clicking the “submit” button on the “account log-in” page and navigating to an “account home” page responsive to clicking the “submit” button; and clicking a “recent purchase history” button to trigger rendering of a table listing the user's recent purchases within the “account home” page.

In this variation, the computer system can append the prompt-including the test statement, the screenshot, and the textual representation of the target webpage—with the website map to provide additional context (e.g., to the language model) related to possible actions within the target webpage and corresponding outcomes associated with these possible actions. The computer system can thus leverage the website map to generate a more-robust prompt input to the language model and thereby improve quality of a response output by the language model responsive to the prompt.

In particular, in this variation, the computer system can: access a test statement defined for a target webpage; capture a screenshot of the target webpage; generate a textual representation of the target webpage-representing target content depicted in the screenshot-based on a set of webpage code generated for the target webpage; and access a website map derived for a website-including the target webpage (or application) and defining pathways between webpages in the set of webpages. The computer system can then: generate a prompt including the test statement, the screenshot, the textual representation, and the website map; and feed the prompt to the language model to generate a response-such as describing an action for executing with the target webpage and including a set of code corresponding to the action—to the test statement accordingly.

Generally, the computer system can: derive the website map during an initial time period; and implement the website map-such as via inclusion in a prompt input to the language model-during a live period succeeding the initial time period.

In particular, in one implementation, during the initial time period, the computer system can generate a prompt to: click on all links—and/or on any selectable elements-present on webpages in the set of webpages (e.g., forming a website) associated with the organization; and—based on webpage origins and destinations between clicks-derive a set of pathways between webpages in the set of webpages accordingly. The computer system can then serve this prompt to the language model to generate the website map representing and/or depicting the set of pathways between the set of webpages associated with the organization.

Additionally or alternatively, in another implementation, the computer system can generate and/or update the website map in (near) real time responsive to execution of various actions-such as including clicking on a link to navigate from a first webpage to a second webpage within a website-during evaluation of a test statement entered by the user via the test portal.

### 7. Website/Organization Profile

Generally, the computer system can generate a website profile for a particular website and/or organization affiliated with the website.

In particular, the computer system can store historical data generated for a target webpage and/or website-such as including a website map derived for the website, a corpus of historical test statements generated for the target webpage and/or website, and/or a corpus of historical actions executed on the target webpage and/or website (e.g., responsive to a test statement)—in a website profile generated for the website and/or organization affiliated with the website.

In one example, the computer system can: write a test statement (e.g., received from a user) entered for a target webpage, within a website, to a test data packet; write a description of a sequence of actions executed to achieve a target outcome specified by the test statement-such as including entering text within a particular text field, clicking a particular button rendered adjacent the text field, etc.—to the test data packet; store the test data packet, in a set of test data packets, generated for the website; and link the set of test data packets to a website profile generated for the website. The computer system can then leverage this set of test data packets to generate a more-robust prompt (e.g., in the future) responsive to receipt of the (identical) test statement for the target webpage. In particular, the computer system can append a prompt-input to the language model and including the test statement, the corresponding screenshot, and the corresponding textual representation of the target webpage—with the test data packet describing the sequence of steps previously executed within the target webpage to achieve the target outcome specified in the test statement.

In one implementation, the computer system can store this information in a knowledge graph associated with the target webpage, website, and/or application (e.g., native or web application). The computer system can then pass this knowledge graph to the language model—in combination with a corresponding prompt—to generate responses to the test statement.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a test statement defining a target outcome associated with contents of a target webpage affiliated with an organization;
capturing a first screenshot of a first region of the target webpage depicting a first set of target content and rendered within a viewport;
accessing a set of webpage code defined for the target webpage and corresponding to the first set of target content depicted in the first screenshot;
transforming the set of webpage code into a first sequence of contextual tags corresponding to the first set of target content depicted in the first screenshot to generate a first textual representation of the target webpage;
generating a first prompt comprising the test statement, an address corresponding to the target webpage, the first screenshot, and the first textual representation of the first set of target content;
accessing a language model configured to generate responses to test statements based on visual and textual content extracted from corresponding prompts;
based on the language model and the first prompt, generating a textual response to the test statement representing occurrence of the target outcome at the target webpage; and
serving the textual response to a user associated with the organization.

2. The method of claim 1:
further comprising annotating the first screenshot with a first set of visual markings corresponding to the first sequence of contextual tags of the first textual representation, each visual marking, in the first set of visual markings, corresponding to a contextual tag in the first sequence of contextual tags; and
wherein generating the first prompt comprising the first screenshot comprises generating the first prompt comprising the first screenshot annotated with the first set of visual markings.

3. The method of claim 2:
wherein transforming the set of webpage code into the first sequence of contextual tags comprises transforming the set of webpage code into the first sequence of contextual tags comprising:
a first contextual tag comprising:
a first text string describing a first interactive feature present on the target webpage; and
a first identifier linked to the first text string; and
a second contextual tag comprising:
a second text string describing a second interactive feature present on the target webpage; and
a second identifier linked to the second text string; and
wherein annotating the first screenshot with the first set of visual markings corresponding to the first sequence of contextual tags comprises:
annotating the first interactive feature, depicted in the first screenshot, with a first visual marking, in the first set of visual markings, corresponding to the first identifier; and
annotating the second interactive feature, depicted in the first screenshot, with a second visual marking, in the first set of visual markings, corresponding to the second identifier.

4. The method of claim 1:
wherein accessing the test statement defining the target outcome comprises accessing the test statement defining the target outcome of presence of a target element on the target webpage; and
wherein generating the textual response to the test statement representing occurrence of the target outcome at the target webpage comprises:
in response to the first textual representation and the first screenshot indicating presence of the target element on the target webpage, generating the textual response of “true” responsive to the test statement and indicating presence of the target element on the target webpage; and
in response to the first textual representation and the first screenshot indicating absence of the target element from the target webpage, generating the textual response of “false” responsive to the test statement and indicating absence of the target element from the target webpage.

5. The method of claim 1:
further comprising:
capturing a second screenshot of a second region of a first instance of the target webpage depicting a second set of target content and rendered within the viewport;
accessing a second set of webpage code defined for the first instance of the target webpage and corresponding to the second set of target content depicted in the second screenshot;
transforming the second set of webpage code into a second sequence of contextual tags corresponding to the second set of target content to generate a second textual representation of the first instance of the target webpage;
generating a second prompt comprising the test statement, the second screenshot, and the second textual representation of the second set of target content;
based on the language model and the second prompt, generating a second response:
describing a first action executable within the second instance of the target webpage and predicted to yield the target outcome; and
comprising a first set of code corresponding to the first action; and
executing the first action within the first instance of the target webpage according to the first set of code;
wherein capturing the first screenshot of the first region of the target webpage comprises capturing the first screenshot of the first region of a second instance of the target webpage depicting the first set of target content rendered within the viewport responsive to execution of the first action;
wherein accessing the set of webpage code defined for the target webpage comprises accessing the set of webpage code defined for the second instance of the target webpage;
wherein transforming the set of webpage code into the first sequence of contextual tags to generate the first textual representation of the target webpage comprises transforming the set of webpage code into the first sequence of contextual tags to generate the first textual representation of the second instance of the target webpage; and
wherein generating the first prompt comprises generating the first prompt comprising the test statement, the first screenshot, and first textual representation of the first set of target content, and a description of the first action executed within the first instance of the target webpage.

6. The method of claim 1:
wherein accessing the set of webpage code defined for the target webpage comprises accessing the set of webpage code defined for the target webpage and defining a first data size; and
wherein transforming the set of webpage code into the first sequence of contextual tags to generate the first textual representation comprises transforming the set of webpage code into the first sequence of contextual tags to generate the first textual representation of a second data size less than the first data size.

7. The method of claim 1:
wherein accessing the test statement comprises receiving the test statement from an instance of a test portal executing on a computing device accessed by the user; and
wherein serving the textual response to the user comprises serving the textual response to the instance of the test portal accessed by the user.

8. The method of claim 1:
further comprising accessing a website map:
defined for a set of webpages comprising the target webpage; and
representing a corpus of sequences of actions executed across the set of webpages to achieve a set of target outcomes; and
wherein generating the prompt comprising the test statement, the address, the first screenshot, and the first textual representation comprises generating the prompt comprising the test statement, the address, the first screenshot, the first textual representation, and the website map.

9. A method comprising:
accessing a test statement defining a target outcome associated with contents of a target webpage;
capturing a first screenshot of a first region of a first instance of the target webpage depicting a first set of target content rendered within a viewport;
accessing a set of webpage code defined for the target webpage and corresponding to contents of the target webpage;
generating a first textual representation of the target webpage by transforming the set of webpage code into a first sequence of contextual tags corresponding to the first set of target content;
generating a first prompt comprising the test statement, an address corresponding to the target webpage, the first screenshot, and the first textual representation of the first set of target content;
accessing a language model configured to generate responses to test statements based on visual and textual content extracted from corresponding prompts;
based on the language model and the first prompt, generating a first response:
describing a first sequence of actions executable within the target webpage and predicted to yield the target outcome; and
comprising a first set of code corresponding to the first sequence of actions;
executing the first sequence of actions within the target webpage according to the first set of code; and
in response to executing the first sequence of actions:
capturing a second screenshot of a region of a second instance of the target webpage depicting a second set of target content rendered within the viewport responsive to execution of the first sequence of actions;
generating a second textual representation of the target webpage by transforming the set of webpage code into a second sequence of contextual tags corresponding to the second set of target content;
generating a second prompt comprising the test statement, the second screenshot, and the second textual representation;
based on the language model and the second prompt, generating a second response to the test statement representing occurrence of the target outcome; and
serving the second response to a user associated with the target webpage.

10. The method of claim 9:
further comprising:
annotating the first screenshot with a first set of visual markings corresponding to the first sequence of contextual tags of the first textual representation, each visual marking, in the first set of visual markings, corresponding to a contextual tag in the first sequence of contextual tags; and
annotating the second screenshot with a second set of visual markings corresponding to the second sequence of contextual tags of the second textual representation, each visual marking, in the second set of visual markings, corresponding to a contextual tag in the second sequence of contextual tags;
wherein generating the first prompt comprising the first screenshot comprises generating the first prompt comprising the first screenshot comprising the first set of visual markings; and
wherein generating the second prompt comprising the second screenshot comprises generating the second prompt comprising the second screenshot comprising the second set of visual markings.

11. The method of claim 10:
wherein transforming the set of webpage code into the first sequence of contextual tags comprises transforming the set of webpage code into the first sequence of contextual tags comprising:
a first contextual tag comprising:
a first text string describing a first interactive feature present on the target webpage; and
a first identifier linked to the first text string; and
a second contextual tag comprising:
a second text string describing a second interactive feature present on the target webpage; and
a second identifier linked to the second text string; and
wherein annotating the first screenshot with the first set of visual markings corresponding to the first sequence of contextual tags comprises:
annotating the first interactive feature, depicted in the first screenshot, with a first visual marking, in the first set of visual markings, corresponding to the first identifier; and
annotating the second interactive feature, depicted in the first screenshot, with a second visual marking, in the first set of visual markings, corresponding to the second identifier.

12. The method of claim 9, wherein generating the second response comprises generating the textual response representing occurrence of the target outcome at the target webpage and describing the first sequence of actions completed to achieve the target outcome.

13. The method of claim 9:
further comprising accessing a website map:
defined for a set of webpages comprising the target webpage; and
representing a corpus of sequences of actions executed across the set of webpages to achieve a set of target outcomes; and
wherein generating the first prompt comprising the test statement, the address corresponding to the target webpage, the first screenshot, and the first textual representation of the first set of target content comprises generating the first prompt comprising the test statement, the address corresponding to the target webpage, the first screenshot, the first textual representation of the first set of target content, and the website map.

14. The method of claim 9:
wherein generating the first response describing the first sequence of actions and comprising the first set of code corresponding to the first sequence of actions comprises generating the first response describing a first action and comprising the first set of code corresponding to the first action;
wherein executing the first sequence of actions within the target webpage according to the first set of code comprises executing the first action within the target webpage according to the first set of code; and
wherein capturing the second screenshot of the region of the second instance of the target webpage responsive to execution of the first sequence of actions comprises capturing the second screenshot of the region of the second instance of the target webpage responsive to execution of the first action.

15. The method of claim 14:
further comprising, in response to executing the first action:
capturing a third screenshot of a region of a third instance of the target webpage depicting a third set of target content rendered within the viewport responsive to execution of the first action;
generating a third textual representation of the target webpage by transforming the set of webpage code into a third sequence of contextual tags corresponding to the third set of target content;
generating a third prompt comprising the test statement, the third screenshot, the third textual representation, a description of the first action executed within the target webpage, and a first instruction to not repeat the first action;
based on the language model and the third prompt, generating a third response:
describing a second action executable within the target webpage and predicted to yield the target outcome; and
comprising a second set of code corresponding to the second action; and
executing the second action within the target webpage according to the second set of code; and
wherein capturing the second screenshot of the region of the second instance of the target webpage responsive to execution of the first action comprises capturing the second screenshot of the region of the second instance of the target webpage responsive to execution of the first action and the second action.

16. The method of claim 15:
wherein accessing the test statement defining the target outcome comprises accessing the test statement defining the target outcome associated with submission of information within a text field rendered on the target webpage;
wherein executing the first action within the target webpage comprises writing text within the text field rendered on the target webpage; and
wherein executing the second action within the target webpage comprises clicking a submit button rendered adjacent the text field within the target webpage.

17. The method of claim 15:
further comprising, in response to executing the second action:
capturing a fourth screenshot of a region of a fourth instance of the target webpage depicting a fourth set of target content rendered within the viewport responsive to execution of the second action;
generating a fourth textual representation of the target webpage by transforming the set of webpage code into a fourth sequence of contextual tags corresponding to the fourth set of target content;
generating a fourth prompt comprising the test statement, the fourth screenshot, the fourth textual representation, a description of the first action executed within the target webpage, a description of the second action executed within the target webpage, the first instruction to not repeat the first action, and a second instruction to not repeat the second action;
based on the language model and the fourth prompt, generating a fourth response:
describing a third action executable within the target webpage and predicted to yield the target outcome; and
comprising a third set of code corresponding to the third action; and
executing the third action within the target webpage according to the third set of code; and
wherein capturing the second screenshot of the region of the second instance of the target webpage responsive to execution of the first action comprises capturing the second screenshot of the region of the second instance of the target webpage responsive to execution of the first action, the second action, and the third action.

18. The method of claim 9:
further comprising:
in response to failure to execute the first sequence of actions according to the first set of code, generating a third prompt comprising:
the test statement;
the address corresponding to the target webpage;
the first screenshot;
the first textual representation;
a description of the first sequence of actions and the first set of code; and
a first instruction to not repeat the first sequence of actions;
based on the language model and the third prompt, generating a second set of code corresponding to a second sequence of actions executable within the target webpage and predicted to yield the target outcome; and
executing the second sequence of actions within the target webpage according to the third set of code; and
wherein capturing the second screenshot of the second region of the target webpage comprises capturing the second screenshot of the second region of the target webpage in response to execution of the second sequence of actions according to the second set of code.

19. A method comprising:
accessing a test statement defining a target outcome associated with contents of a target webpage;
capturing a first screenshot of a region of a first target webpage, in a set of webpages, depicting a first set of target content rendered within a viewport;
accessing a first set of webpage code defined for the first target webpage and corresponding to contents of the first target webpage;
generating a first textual representation of the first target webpage by transforming the set of webpage code into a first sequence of contextual tags corresponding to the first set of target content depicted in the first screenshot;
generating a first prompt comprising the test statement, the first screenshot, and the first textual representation of the first set of target content;
accessing a language model configured to generate responses to test statements based on visual and textual content extracted from corresponding prompts;
based on the language model and the first prompt, generating a first response:
describing a first action executable within the target webpage and predicted to yield the target outcome; and
comprising a first set of code corresponding to the first action;
triggering execution of the first action within the target webpage according to the first set of code;
in response to failure to execute the first action, generating a second prompt comprising the test statement, the first screenshot, the first textual representation, a description of the first action and the first set of code, and a first instruction to not repeat the first action;
based on the language model and the second prompt, generating a second response:
describing a second action executable within the target webpage and predicted to yield the target outcome; and
comprising a second set of code corresponding to the second action;
triggering execution of the second action within the target webpage according to the second set of code; and
in response to execution of the second action:
capturing a second screenshot of a region of a second instance of the target webpage depicting a second set of target content rendered within the viewport responsive to execution of the first sequence of actions;
generating a second textual representation of the target webpage by transforming the set of webpage code into a second sequence of contextual tags corresponding to the second set of target content;
generating a third prompt comprising the test statement, the second screenshot, the second textual representation, and a description of the second action;
based on the language model and the third prompt, generating a third response to the test statement representing occurrence of the target outcome and describing the second action; and
serving the third response to a user associated with the target webpage.

20. The method of claim 19:
further comprising:
annotating the first screenshot with a first set of visual markings corresponding to the first sequence of contextual tags of the first textual representation, each visual marking, in the first set of visual markings, corresponding to a contextual tag in the first sequence of contextual tags; and
annotating the second screenshot with a second set of visual markings corresponding to the second sequence of contextual tags of the second textual representation, each visual marking, in the second set of visual markings, corresponding to a contextual tag in the second sequence of contextual tags;
wherein generating the first prompt comprising the first screenshot comprises generating the first prompt comprising the first screenshot comprising the first set of visual markings; and
wherein generating the second prompt comprising the second screenshot comprises generating the second prompt comprising the second screenshot comprising the second set of visual markings.
